(19) United States
(12) Patent Application Publication
(10) Pub. No.: US 2014/0095289 A1
(43) Pub. Date: Apr. 3, 2014

(54) METHOD AND APPARATUS FOR FACILITATING AN ONLINE TRANSACTION

(71) Applicant: Michael John Mobberley, Thames (NZ)

(72) Inventor: Michael John Mobberley, Thames (NZ)

(21) Appl. No.: 14/002,355

(22) PCT Filed: Mar. 1, 2012
(86) PCT No.: PCT/IB12/50954

§ 371 Date: Dec. 12, 2013

(30) Foreign Application Priority Data
Mar. 1, 2011 (NZ) 591465

(51) Int. Cl. G06Q 30/02

(52) U.S. Cl. CPC G06Q 30/0233
USPC 705/14.33

(57) ABSTRACT

The present invention relates to an electronic transaction system that facilitates electronic transactions where one or more initial transactions and one or more subsequent transactions are carried out. The subsequent transactor accrues a certain amount of credit based on the value and/or nature of the subsequent transaction. The subsequent transactor must then allocate the accrued credit to an initial transactor or initial transaction, or this may be carried out automatically for them to random initial transactors. In return, the initial transactor may accrue further credit in an even more subsequent transaction, and allocate it to the subsequent transactor, thereby repaying the favour.

### TECHNICAL FIELD

The present invention relates to a method and system for facilitating an online transaction. More particularly but not exclusively it relates to a method of providing an online electronic transaction service by means of an electronic transaction system, and an electronic system therefor.

### BACKGROUND OF THE INVENTION

Presently, electronic transactions such as retail sales, hire, leasing etc, are provided online over networks such as the Internet. These services offer goods or services for sale, hire or lease. Other known transaction types are also envisaged.

Internet users may access a database of items (i.e. goods or services) goods for transacting in over the Internet, designate the goods or item they want to transact in, and arrange for the transaction to be carried out. In some cases this may mean making payment for goods. The goods may then be shipped to the customers. This is an example of a typical “offer and acceptance” type format for a transaction.

In another format, as may be found on EBay® goods may be offered for sale in an auction type format, wherein a user may enter a bid for a selected item. The user who has entered the highest bid by a predetermined cut-off date will win the auction, and once payment has been arranged, will have the item sold to them at the price at which they made a bid.

Such online transaction services may be convenient for users to transact on items or services from their home or work.

However, such retail services do not typically offer incentives for users to remain loyal to the online retail provider. Loyalty programmes may be offered, whereby customers are rewarded in some form after they have transacted to a predefined amount, or up a particular number of transactions in the past.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### OBJECT OF THE INVENTION

It is an object of the present invention to provide a method and system for providing a retail service which overcomes or at least partially ameliorates some of the abovementioned disadvantages or which at least provides the public with a useful choice.

### SUMMARY OF THE INVENTION

In a first aspect the present invention may be said to broadly consist in a method of facilitating a retail service, preferably enabled by an electronic retail system, said method comprising the steps of:
receiving an initial purchase instruction from said initial purchaser for purchase of at least an initial item in an initial transaction;
assigning an initial purchase code associated with the initial transaction;
receiving a subsequent purchase instruction from a subsequent purchaser for purchase of at least one subsequent item in a subsequent transaction;
receiving the initial purchase code from the subsequent purchaser; and
crediting the initial purchaser.

In one embodiment, the method includes the step of
presenting at least an initial item for sale to an initial purchaser;

In one embodiment, the method includes the step of
receiving confirmation of payment for the initial item as an initial transaction;

In one embodiment, the method includes the step of
presenting at least a subsequent item for sale;

In one embodiment, the method includes the step of
receiving confirmation of payment for the subsequent item as a subsequent transaction;

In one embodiment, the method includes the step of:
setting up an initial purchaser account with the initial purchaser.

In one embodiment, the method includes the step of assigning an initial transactor code to the initial transaction.

In one embodiment, the method includes the step of automatically assigning an initial transactor code to the initial transaction.

In one embodiment, the method includes the step of assigning an initial transactor code associated with the initial purchaser.

In one embodiment, the initial purchase code is linked to the initial transactor code.

In one embodiment, the initial purchase code is the initial transactor code.

In one embodiment, the step of crediting the initial purchaser is by crediting the initial purchaser account of the initial purchaser.

In one embodiment, the method includes the step of
receiving details of a subsequent purchaser.

In one embodiment, the method includes the step of
assigning a subsequent purchaser code to the subsequent purchaser.

In one embodiment, the method includes the step of
setting up a subsequent purchaser account with the subsequent purchaser.

In one embodiment, the initial item and subsequent item are similar goods.

Alternatively, the initial item and subsequent items are not similar goods.

In one embodiment, the initial item and subsequent item are goods of similar value.

In one embodiment, the value of the subsequent item is at least equal to the value of the initial item.

Alternatively, the initial item and subsequent items are not of similar value.
In one embodiment, one or more selected from the initial item and the subsequent item are presented for sale over a network.
In one embodiment, one or more selected from the initial item and the subsequent item are presented for sale over a network on at least one remote terminal

In one embodiment, the remote terminal is a home computer.

In one embodiment, the network is the Internet.
In one embodiment, the item is presented for sale by transmitting a signal indicative of one or more selected from the initial item and the subsequent item over the network.
In one embodiment, one or more selected from the initial item and the subsequent item is presented for sale in response to an interrogation signal sent by one or more selected from the initial purchaser and the subsequent purchaser respectively, from a remote terminal.
In one embodiment, the interrogation signal initiates a search of a database of items for sale.

In one embodiment, the [symbol]
In one embodiment, the step of presenting one or more selected from the initial item and the subsequent item is by redirecting the initial purchaser or subsequent purchaser to a webpage.
In one embodiment, the step of presenting one or more selected from the initial item and the subsequent item is by redirecting the initial purchaser or subsequent purchaser to a webpage, while identifying the redirection as coming from the retail service provider.

In one embodiment, the method includes the step of facilitating payment for one or more selected from the initial item and the subsequent item.

In one embodiment, the step of facilitating payment comprises the step of guiding a purchaser to a payment website.

In one embodiment, the step of facilitating payment of one or more selected from the initial item and the subsequent item includes the step of receiving payment instructions from one or more selected from the initial purchaser and the subsequent purchaser respectively.

In one embodiment, the step of receiving confirmation of payment for one or more selected from the initial item and the subsequent item (s) includes the step of receiving payment.

In one embodiment, the receiving of payment may be from a payment facilitation service.

In one embodiment, the payment facilitation service may be a credit card facility or an online payment facilitator such as PayPal.

Alternately, the receiving of payment may be from the purchaser directly.

In one embodiment, the step of receiving an instruction from said initial purchaser for the purchase of at least an initial item includes receiving an instruction signal from a remote terminal.

In one embodiment, the step of receiving an instruction from said initial purchaser for the purchase of at least an initial item includes receiving an instruction signal from a remote terminal over a network.

In one embodiment, the remote terminal is one or more selected from an electronic device having a Web-browsing capacity.

In one embodiment, the remote terminal is one or more selected from:
a personal computer;
a tablet type device;
a mobile phone
or the like.

In one embodiment, the network is the Internet.

In one embodiment, the step of receiving the initial purchase code from the subsequent purchaser includes the step of searching a list of previous transactions.

In one embodiment, the step of receiving the initial purchase code from the subsequent purchaser includes the step of presenting one or more previous transactions to the subsequent purchaser.

In one embodiment, the previous transactions are associated with a previous purchaser.

In one embodiment, the previous purchaser is the initial purchaser.

In one embodiment, the step of receiving the initial purchase code from the subsequent purchaser includes the step of receiving an instruction from the subsequent purchaser to reference a previous transaction.

In one embodiment, the step of receiving the initial purchase code from the subsequent purchaser includes the step of setting the referenced previous transaction as the initial transaction.

In one embodiment, the method of providing a retail service comprises the step of receiving from one or more selected from said initial purchaser or said subsequent purchaser association information.

In one embodiment, the association information includes one or more selected from:
associated purchasers;
transactions associated with the associated purchasers;
transactions associated with the initial purchase code;
transactions associated with type of product; and
transactions that remain within the threshold time limit.

In one embodiment, the method comprises the step of creating an association between one selected from the initial purchaser and the subsequent purchaser and the association information.

In one embodiment, the step of presenting one or more previous transactions to the subsequent purchaser includes the step of interrogating a list of previous transactions for at least part of the association information.

In one embodiment, the step of presenting one or more previous transactions to the subsequent purchaser includes the step of presenting one or more previous transactions to the subsequent purchaser in response to the interrogation of the list of previous transactions.

In one embodiment, the credit amount is a predetermined percentage of the subsequent transaction value.

In one embodiment, the method comprises the step of a comparing the subsequent transaction value to a predetermined comparison amount.

In one embodiment, the predetermined comparison amount is the initial transaction value.
In one embodiment, the method comprises the step of receiving an instruction from one or more subsequent purchasers for purchase of a plurality of subsequent items.
In one embodiment, the method comprises the step of receiving confirmation of payment for the plurality of subsequent items as subsequent transactions.
In one embodiment, separate instructions are received from one or more subsequent purchasers for purchase of a plurality of subsequent items as subsequent transactions.

In one embodiment, the method includes the step of summing a total of the subsequent transaction values.

In one embodiment, the step of crediting the initial purchaser may be by crediting them by an amount in monetary terms.

In one embodiment, one step of crediting the initial purchaser may be by crediting them by an equivalent item to that purchased in the initial and/or subsequent transaction.

In one embodiment, the step of crediting the initial purchaser by a credit amount occurs after the summed subsequent transaction values exceeds a threshold amount.

In one embodiment, the threshold amount is equal to a predetermined percentage of the initial transaction value.

In one embodiment, the threshold amount is equal to the price of the initial transaction value.

In one embodiment, the subsequent purchaser of the subsequent item is the same person as the initial purchaser.

Alternately, the subsequent purchaser of the subsequent items is not the same person as the initial purchaser.

In one embodiment, the method includes the step of assigning a subsequent purchaser code to the subsequent purchaser.

In one embodiment, the method comprises the step of comparing one or more selected from the date of payment of the subsequent item and the date that the subsequent purchase instruction was received with one or more selected from the date of payment of the initial item and the date that the initial purchase instruction was received, to determine a time lapse.

In one embodiment, the method includes the step of comparing the time lapse to one or more predetermined time lapse thresholds.

In one embodiment, the amount that the initial purchaser is credited by is dependent on the comparison of the time lapse with the time lapse threshold(s).

In one embodiment, if the time lapse is more than a predetermined time lapse threshold period, then the initial purchaser is not credited at all.

In one embodiment, the predetermined time lapse threshold period is between 1 and 8 months.

In one embodiment, the predetermined time lapse threshold period is between 2 and 4 months.

In one embodiment, the method may include the step of comparing the time lapse to a plurality of predetermined time lapse thresholds, wherein the amount that the initial purchaser is credited by is reduced as the time lapse gets longer.

In one embodiment, the step of crediting the initial purchaser includes the step of facilitating or causing a payment to the purchaser.

Alternately, the step of crediting the initial purchaser includes the step of crediting the initial purchaser account.

In one embodiment, the method may include the step of initiating the process of delivery of the purchased item to an address designated by the initial purchaser.

In another aspect the present invention may be said to broadly consist in a method of using a retail service, preferably enabled by an electronic retail system, said method comprising the steps of:
sending an initial purchase instruction for the purchase of at least one initial item in an initial transaction;
receiving a signal indicative of an initial purchase code associated with the initial transaction; and
being credited by said electronic retail system in the event that a subsequent transaction for the purchase of one or more subsequent items is initiated, and the initial purchase code is referenced.

In one embodiment, the method includes the step of
receiving notification of having been credited.

In one embodiment, the method includes the step of
sending an initial interrogation signal for interrogating an item database.

In one embodiment, the method includes the step of
receiving an initial presentation signal presenting at least an initial item for sale.

In one embodiment, the method includes the step of
sending an initial payment signal to facilitate payment of at least the initial transaction value for payment of at least the initial item.

In one embodiment, the method includes the step of
sending a subsequent interrogation signal for interrogating an item database.

In one embodiment, the method includes the step of
receiving a subsequent presentation signal for presenting at least a subsequent item for sale.

In one embodiment, the method includes the step of
sending a subsequent purchase instruction for the purchase of at least one subsequent item in a subsequent transaction.

In one embodiment, the method includes the step of
sending a subsequent payment signal to facilitate payment of at least part of the value of the subsequent transaction.

In one embodiment, the method includes the step of
sending an initial purchase code signal for the purposes of referencing the subsequent transaction to the initial transaction.

In one embodiment, the method includes the step of:
sending details of the initial purchaser to the electronic retail system for purposes of setting up an initial purchaser account.

In one embodiment, the method includes the step of:
receiving an assigned initial transactor code associated with the initial purchaser account from the electronic retail system.

In one embodiment, the method includes the step of:
receiving an assigned subsequent purchase code associated with the subsequent purchase from the electronic retail system.

In one embodiment, the method comprises the step of transmitting association information as to the nature of transactions that can be presented for selection by said subsequent purchaser.

In one embodiment, the association information includes one or more selected from:
associated purchasers;
transactions associated with associated purchasers;
transactions associated with the initial purchase code;
transactions associated with type of product; and
transactions that remain within the threshold time limit.

In one embodiment, the method comprises the step of instructing the creation of an association between the initial purchaser and the association information.

In another aspect the present invention may be said to broadly consist in a method of using a retail service on an electronic retail system on which a prior initial transaction has been completed, and against which an initial purchase code has been issued, said method comprising the steps of:
sending a subsequent purchase instruction signal to signal intention to purchase at least one subsequent item in a subsequent transaction; and
sending an initial purchase code signal associated with said initial transaction. for the purposes of referencing the subsequent transaction to said initial transaction.

In one embodiment, the method includes the step of:
sending a subsequent interrogation signal for interrogating an item database.

In one embodiment, the method includes the step of
receiving a subsequent presentation signal presenting at least one subsequent item for sale.

In one embodiment, the method includes the step of
sending a subsequent payment signal to facilitate payment of at least part of the subsequent transaction value for payment of at least the subsequent item.

In one embodiment, the method includes the step of:
sending details of the subsequent purchaser to the electronic retail system for purposes of setting up a subsequent purchaser account.

In one embodiment, the method includes the step of:
receiving an assigned subsequent purchaser code associated with the subsequent purchaser account from the electronic retail system.

In one embodiment, the method includes the step of:
receiving an assigned subsequent purchase code associated with the subsequent purchase from the electronic retail system.

In one embodiment, the method comprises the step of transmitting association information to an electronic retail provider.

In one embodiment, the association information includes one or more selected from:
at least one associated purchaser;
transactions associated with an associated purchaser;
transactions associated with an initial purchase code;
transactions associated with type of product; and
transactions that remain within the threshold time limit.

In one embodiment, the method comprises the step of instructing the creation of an association between the subsequent purchaser and association information.

In one embodiment, the method comprises the step of instructing a search be conducted based on any of the association information.

In one embodiment, the method comprises the step of instructing a search be conducted for previous transactions associated with an associated purchaser.

In one embodiment, the method comprises the step of selecting one or more previous transactions from a list of previous transactions associated with an associated purchaser.

In one embodiment, the method comprises the step of sending an instruction to reference a previous transaction associated with an associated purchaser for the purpose of using as the initial transaction.

In another aspect, the invention may be said to consist in an electronic retail system, on which purchasers may purchase at least one item presented for sale, said retail system comprising
a receiver for receiving signals from a remote terminal
a transmitter for transmitting signals for display on a remote terminal;
a processor for processing information according to a set of instructions;
digital storage media comprising a set of instructions adapted and configured for directing said electronic retail system to:
   receive an initial purchase instruction from an initial purchaser for purchase of at least an initial item in an initial transaction;
   assign an initial purchase code associated with the initial transaction;
   receive a subsequent purchaser instruction from a subsequent purchaser for purchase of at least one subsequent item in a subsequent transaction;
   receive the initial purchase code from the subsequent purchaser; and
   credit the initial purchaser.

In one embodiment, the instructions are adapted and configured for directing said electronic retail system to:
present at least an initial item for sale to an initial purchaser.

In one embodiment, the instructions are adapted and configured for directing said electronic retail system to:
receive confirmation of payment for the initial item as an initial transaction.

In one embodiment, the instructions are adapted and configured for directing said electronic retail system to:
present at least a subsequent item for sale.

In one embodiment, the instructions are adapted and configured for directing said electronic retail system to:
receive confirmation of payment for the subsequent item as a subsequent transaction.

In one embodiment, the instructions are adapted and configured for directing said electronic retail system to:
set up an initial purchaser account with the initial purchaser.

In one embodiment, the instructions are adapted and configured for directing said electronic retail system to:
assign an initial transactor code to the initial transaction.

In one embodiment, the instructions are adapted and configured for directing said electronic retail system to:
assign an initial transactor code associated with the initial purchaser.

In one embodiment, the instructions are adapted and configured for directing said electronic retail system to link the initial purchase code to the initial transactor code.

In one embodiment, the initial purchase code is the initial transactor code.

In one embodiment, the instructions are adapted and configured for directing said electronic retail system to credit the initial purchaser by crediting the initial purchaser account of the initial purchaser.

In one embodiment, the instructions are adapted and configured for directing said electronic retail system to:
receive details of a subsequent purchaser.

In one embodiment, the instructions are adapted and configured for directing said electronic retail system to:
assign a subsequent purchaser code to the subsequent purchaser.

In one embodiment, the instructions are adapted and configured for directing said electronic retail system to:
set up a subsequent purchaser account for the subsequent purchaser.

In one embodiment, the initial item and subsequent item are similar goods.

Alternatively, the initial item and subsequent items are not similar goods.

In one embodiment, the initial item and subsequent item are goods of similar value.

In one embodiment, the value of the subsequent item is at least equal to the value of the initial item.

Alternatively, the initial item and subsequent items are not of similar value.

In one embodiment, the electronic retail system comprises an item database that contains details of items that can be bought by purchasers.

In one embodiment, the item database includes any one or more of the following:
item name;
description of the item;
nature of the item;
price of the item;
colour of the item;
discounts that may be relevant to that item;
supplier of the item; and
minimum number of items to be sold together.

In one embodiment, the electronic retail system comprises a purchaser database that contains details of registered purchasers

In one embodiment, the details of registered users includes any one or more of the following:
name(s) of the purchaser;
user names/handle of the purchaser;
address of purchaser;
purchaser's payment facilitation details (such as credit card number, Paypal account number, etc);
purchaser's contact details;
an associated purchaser code
past purchases made by the purchaser;
purchase codes associated with each of the past purchases made by the purchaser.

In one embodiment, the electronic retail system comprises a purchaser database.

In one embodiment, the purchase database comprises details of previous purchases.

In one embodiment, the details of previous purchases include at least any one or more of
item sold,
item code;
items details;
transaction value;
tax value on transaction;
transaction details (for example auction bids received)
date and/or time of sale
purchaser details
purchaser's association information.

In one embodiment, the instructions are adapted and configured for directing said electronic retail system to present one or more selected from the initial item and the subsequent item for sale over a network.

In one embodiment, said one or more selected from the initial item and the subsequent item are presented for sale over a network on at least one remote terminal.

In one embodiment, the items presented for sale are presented as an offer and acceptance sale format.

Alternatively, the items presented for sale are presented in an auction type format.

In one embodiment, the remote terminal is one or more selected from a
a home computer;
a wirelessly enabled mobile electronic device;
a laptop;
mobile phone; and
a tablet device.

In one embodiment, the network is the Internet.

In one embodiment, the instructions are adapted and configured for directing said electronic retail system to present one or more selected from the initial item and the subsequent item for sale by transmitting a signal indicative of one or more selected from the initial item and the subsequent item over the network.

In one embodiment, the instructions are adapted and configured for directing said electronic retail system to present one or more selected from the initial item and the subsequent item for sale in response to an interrogation signal sent by one or more selected from the initial purchaser and the subsequent purchaser respectively, from a remote terminal.

In one embodiment, the electronic retail system comprises one or more item databases of items for sale.

In one embodiment, the interrogation signal initiates a search of the item database(s) of items for sale.

In one embodiment, the electronic retail system comprises one or more purchaser databases of items for sale.

In one embodiment, the instructions are adapted and configured for directing said electronic retail system to interrogate the purchaser database in response to the reception of a purchaser code.

In one embodiment, the electronic retail system comprises one or more purchases databases of items that have been purchased.

In one embodiment, the instructions are adapted and configured for directing said electronic retail system to interrogate the purchases database in response to the reception of an initial purchase code.

In one embodiment, the instructions are adapted and configured for instructing said processor to present one or more selected from the initial item and the subsequent item is by redirecting the initial purchaser or subsequent purchaser to a webpage.

In one embodiment, the instructions are adapted and configured for instructing said processor to presenting one or more selected from the initial item and the subsequent item by redirecting the initial purchaser or subsequent purchaser to a webpage, while identifying the redirection as coming from the retail service provider.

In one embodiment, the instructions are adapted and configured for directing said electronic retail system facilitate payment of one or more selected from the initial item and the subsequent item.

In one embodiment, the instructions are adapted and configured for directing said electronic retail system to facilitate payment by guiding or directing a purchaser to a payment website.

In one embodiment, the instructions are adapted and configured for directing said electronic retail system to facilitate payment of one or more selected from the initial item and the subsequent item after receiving payment instructions from one or more selected from the initial purchaser and the subsequent purchaser respectively.

In one embodiment, the instructions are adapted and configured for directing said electronic retail system to receive an instruction from said initial purchaser for the purchase of at least an initial item by receiving an instruction signal from a remote terminal.

In one embodiment, the instruction signal is received from a remote terminal over a network.

In one embodiment, the remote terminal is an electronic device having a Web-browsing capacity.

In one embodiment, the remote terminal is one or more selected from:
a personal computer;
a tablet type device;
a mobile phone;
a wireless enabled device;
or the like.

In one embodiment, the network is the Internet.

In one embodiment, the instructions are adapted and configured for instructing said processor to receive the initial purchase code from the subsequent purchaser after searching a list of previous transactions.

In one embodiment, the instructions are adapted and configured for instructing said processor to receive the initial purchase code from the subsequent purchaser after presenting one or more previous transactions to the subsequent purchaser.

In one embodiment, the previous transactions are associated with a previous purchaser.

In one embodiment, the previous purchaser is the initial purchaser.

In one embodiment, the instructions are adapted and configured for instructing said processor receive an instruction from the subsequent purchaser to reference a presented previous transaction.

In one embodiment, the instructions are adapted and configured for instructing said processor to set the referenced previous transaction as the initial transaction.

In one embodiment, the instructions are adapted and configured for instructing said processor to receive from one or more selected from said initial purchaser or said subsequent purchaser, association information that can be used for interrogation of previous transactions and presented for selection by said subsequent purchaser.

In one embodiment, the information as to the nature of the transactions includes one or more selected from:
associated purchasers;
transactions associated with associated purchasers;
transactions associated with the initial purchase code;
transactions associated with type of product; and
transactions that remain within the threshold time limit

In one embodiment, the instructions are adapted and configured for instructing said processor to create an association between one selected from the initial purchaser and the subsequent purchaser and the association information.

In one embodiment, the instructions are adapted and configured for instructing said processor to interrogating a list of previous transactions for associated information.

In one embodiment, the instructions are adapted and configured for instructing said processor to present one or more previous transactions to the subsequent purchaser in response to the interrogation of the list of previous transactions.

In one embodiment, the instructions are adapted and configured for directing said electronic retail system to receive payment for one or more selected from the initial item and the subsequent item(s).

In one embodiment, the instructions are adapted and configured for directing said electronic retail system to receive payment from a payment facilitation service.

In one embodiment, the payment facilitation service may be a credit card facility or an online payment facilitator, such as PayPal.

Alternately, the instructions are adapted and configured for directing said electronic retail system to receive payment from one or more selected from the initial purchaser and subsequent purchaser directly.

In one embodiment, the method comprises the step of
determining a credit value to be credited to the initial purchaser.

In one embodiment, the credit value is a monetary amount as a predetermined percentage of the subsequent transaction value.

Alternately the credit value is an item of equivalent value or at least part thereof.

In one embodiment, the instructions are adapted and configured for directing said electronic retail system to compare the subsequent transaction value to a predetermined comparison amount.

In one embodiment, the predetermined comparison amount is the initial transaction value.

In one embodiment, the instructions are adapted and configured for directing said electronic retail system to receive at least one purchase signal from one or more subsequent purchasers for purchase of a plurality of subsequent items.

In one embodiment, the instructions are adapted and configured for directing said electronic retail system to receive confirmation of payment for the plurality of subsequent items as subsequent transactions.

In one embodiment, instructions are adapted and configured for directing said electronic retail system to receive separate purchase signals from one or more subsequent purchasers for purchase of a plurality of subsequent items as subsequent transactions.

In one embodiment, the instructions are adapted and configured for directing said electronic retail system to sum a total of the subsequent transaction values.

In one embodiment, the instructions are adapted and configured for directing said electronic retail system to credit the initial purchaser by a credit amount once the summed subsequent transaction values exceeds a threshold amount.

In one embodiment, the threshold amount is equal to a predetermined percentage of the initial transaction value.

In one embodiment, the threshold amount is equal to the initial transaction value.

In one embodiment, the subsequent purchaser of the subsequent item is the same person as the initial purchaser.

Alternately, the subsequent purchaser of the subsequent items is not the same person as the initial purchaser.

In one embodiment, the instructions are adapted and configured for directing said electronic retail system to assign a subsequent purchaser code to the subsequent purchaser.

In one embodiment, the instructions are adapted and configured for instructing said processor to compare one or more selected from the date of payment of the subsequent item and the date that the subsequent purchase instruction was received with one or more selected from the date of payment of the initial item and the date that the initial purchase instruction was received, to determine a time lapse.

In one embodiment, the instructions are adapted and configured for instructing said processor to compare the time lapse to one or more predetermined time lapse thresholds.

In one embodiment, the instructions are adapted and configured for instructing said processor to credit the initial purchaser by an amount that is dependent on the comparison of the time lapse with the time lapse threshold(s).

In one embodiment, the instructions are adapted and configured for instructing said processor to not credit the initial purchaser at all if the time lapse is more than a predetermined time lapse threshold period.

In one embodiment, the predetermined time lapse threshold period is between 1 and 8 months.

In one embodiment, the predetermined time lapse threshold period is between 2 and 4 months.

In one embodiment, the instructions are adapted and configured for instructing said processor to compare the time lapse to a plurality of predetermined time lapse thresholds, wherein the amount that the initial purchaser is credited by is reduced as the time lapse gets longer.

In one embodiment, the instructions are adapted and configured for instructing said processor to credit the initial purchaser by facilitating or causing a payment to the purchaser.

Alternately, the instructions are adapted and configured for instructing said processor to credit the initial purchaser by crediting the initial purchaser account.

In one embodiment, the instructions are adapted and configured for instructing said processor to initiate the process of delivery of the purchased item to an address designated by the initial purchaser.

In another aspect the present invention may be said to broadly consist in a method of providing a retail service by a seller comprising the steps of
selling an initial item to an initial purchaser in an initial transaction; and
crediting the initial purchaser based on one or more selected from the following:
   how many subsequent purchasers subsequently purchase at least one item from the seller in subsequent transactions while referencing the initial purchase;
   the value of subsequent purchases made by subsequent purchasers in subsequent transaction; and
   the date on which the subsequent transactions are made.

In one embodiment, the method of providing a retail service is carried out by an electronic retail system.

In one embodiment, the credited value is a percentage of the value of the initial transaction per subsequent transaction.

In one embodiment, the crediting of the initial purchaser is only carried out per subsequent transaction if the value of that subsequent transaction exceeds a threshold value.

In one embodiment, the crediting of the initial purchaser is only carried out if the combined value of the subsequent transactions exceeds a threshold value.

In one embodiment, the threshold value is a predetermined percentage of the initial transaction value.

In one embodiment, the threshold value is the initial transaction value.

In one embodiment, the method comprises registering the initial purchaser and assigning an initial transactor code to said initial purchaser associate with their registration, the initial transactor code for reference by the subsequent purchasers during their subsequent transaction(s) to enable the initial purchaser to be credited.

In one embodiment, the method comprises assigning an initial transaction code to the initial transaction for reference by the subsequent purchasers during their subsequent transaction(s) to enable the initial purchaser to be credited.

In one embodiment, the initial transaction code is the initial transactor code.

In another aspect the present invention may be said to broadly consist in a method of facilitating an online transaction, enabled by an electronic transaction system through a transaction service provider, said method comprising the steps of:
receiving an initial transaction instruction from an initial transactor for transacting in at least an initial item in an initial transaction;
assigning an initial transaction code associated with the initial transaction;
receiving a subsequent transaction instruction from a subsequent transactor for transacting in at least one subsequent item in a subsequent transaction;
receiving notification of the initial transaction code from the subsequent transactor; and
crediting the initial transactor.

In one embodiment, the method includes the step of presenting at least an initial item to an initial transactor for purposes of transacting in that initial item.

In one embodiment, the method includes the step of receiving one or more selected from payment and confirmation of payment as part of the initial transaction;

In one embodiment, the method includes the step of presenting at least a subsequent item for purposes of transacting in that subsequent item;

In one embodiment, the method includes the step of one or more selected from payment and confirmation of payment as part of the subsequent transaction;

In one embodiment, the method includes the step of setting up an initial transactor account with the initial transactor.

In one embodiment, the method includes the step of assigning an initial transactor code to the initial transaction.

In one embodiment, the method includes the step of automatically assigning an initial transactor code to the initial transaction.

In one embodiment, the method includes the step of assigning an initial transactor code associated with the initial transactor.

In one embodiment, the initial transaction code is linked to the initial transactor code.

In one embodiment, the initial transaction code is the initial transactor code.

In one embodiment, the step of crediting the initial transactor is by crediting the initial transactor account of the initial transactor.

In one embodiment, the method includes the step of receiving details of a subsequent transactor.

In one embodiment, the method includes the step of assigning a subsequent transactor code to the subsequent transactor.

In one embodiment, the method includes the step of setting up a subsequent transactor account with the subsequent transactor.

In one embodiment, one or more selected from the initial item and the subsequent item are presented for transacting over a network on at least one remote terminal

In one embodiment, the item is presented for transacting by transmitting a signal indicative of one or more selected from the initial item and the subsequent item over the network.

In one embodiment, one or more selected from the initial item and the subsequent item is presented for transacting in response to an interrogation signal sent by one or more selected from the initial transactor and the subsequent transactor respectively, from a remote terminal.

In one embodiment, the interrogation signal initiates a search of a database of items for transacting.

In one embodiment, the step of presenting one or more selected from the initial item and the subsequent item is by redirecting the initial transactor or subsequent transactor to a webpage, while identifying the redirection as coming from the transaction service provider.

In one embodiment, the method includes the step of facilitating payment for one or more selected from the initial item and the subsequent item.

In one embodiment, the step of receiving the initial transaction code from the subsequent transactor includes the step of interrogating a database of previous transactions.

In one embodiment, the step of receiving the initial transaction code from the subsequent transactor includes the step of presenting one or more selected from previous transactions and previous transactors to the subsequent transactor for selection as an initial transaction and/or initial transactor respectively.

In one embodiment, the method comprises the step of receiving association information from one or more selected from said initial transactor and said subsequent transactor.

In one embodiment, the association information includes one or more selected from:

associated transactors;

transactions associated with the associated transactors;

transactions associated with the initial transaction code;

transactions associated with type of product; and

transactions that remain within the threshold time limit.

In one embodiment, the method comprises the step of creating an association between one selected from the initial transactor and the subsequent transactor and the association information.

In one embodiment, the step of presenting one or more previous transactions to the subsequent transactor includes the step of interrogating at least part of the association information for a list of previous transactions.

In one embodiment, the step of presenting one or more previous transactions to the subsequent transactor includes the step of presenting one or more previous transactions to the subsequent transactor in response to the interrogation of at least part of the association information for previous transactions.

In one embodiment, the credit amount is a predetermined percentage of the subsequent transaction value.

In one embodiment, the method comprises the step of a comparing the subsequent transaction value to a predetermined comparison amount.

In one embodiment, the step of crediting the initial transactor by a credit amount occurs after the summed subsequent transaction values exceeds one or more selected from a threshold amount and a predetermined threshold percentage of the initial transaction value.

In one embodiment, the subsequent transactor of the subsequent item is the same person as the initial transactor.

In one embodiment, the method comprises the step of comparing one or more selected from the date of payment of the subsequent item and the date that the subsequent transaction instruction was received with one or more selected from the date of payment of the initial item and the date that the initial transaction instruction was received, to determine a time lapse.

In one embodiment, the method includes the step of comparing the time lapse to one or more predetermined time lapse thresholds.

In one embodiment, the amount that the initial transactor is credited by is determined in a manner dependent on the comparison of the time lapse with the time lapse threshold(s).

In one embodiment, the method may include the step of comparing the time lapse to a plurality of predetermined time lapse thresholds, wherein the amount that the initial transactor is credited by is reduced as the time lapse increases.

In one embodiment, the step of crediting the initial transactor includes the step of facilitating or causing a payment to the initial transactor.

In one embodiment, the step of crediting the initial transactor includes the step of crediting the initial transactor account.

In one embodiment, the method may include the step of initiating delivery of the transacted item to an address designated by the initial transactor.

In one embodiment, the transaction is a sale, and the transactor is a purchaser.

In another aspect the present invention may be said to broadly consist in a method of using a transaction service, enabled by an electronic transaction system, said method comprising the steps of:
sending an initial transaction instruction to transact in at least one initial item in an initial transaction;
being assigned an initial transaction code associated with the initial transaction; and
being credited by said electronic transaction system in the event that a subsequent transaction transacting in one or more subsequent items is initiated, and the initial transaction code is referenced.

In one embodiment, the method includes the step of receiving notification of having been credited.

In one embodiment, the method includes the step of sending an initial interrogation signal for interrogating an item database for items that may be transacted in.

In one embodiment, the method includes the step of receiving an initial presentation signal presenting at least an initial item for a transaction.

In one embodiment, the method includes the step of sending an initial payment signal to facilitate payment of at least the initial transaction value for payment of at least the initial item.

In one embodiment, the method includes the step of sending a subsequent interrogation signal for interrogating an item database.

In one embodiment, the method includes the step of receiving a subsequent presentation signal for presenting at least a subsequent item for a transaction.

In one embodiment, the method includes the step of sending a subsequent transaction instruction for transacting in at least one subsequent item in a subsequent transaction.

In one embodiment, the method includes the step of sending a subsequent payment signal to facilitate payment of at least part of the value of the subsequent transaction.

In one embodiment, the method includes the step of sending an initial transaction code signal for the purposes of referencing the subsequent transaction to the initial transaction.

In one embodiment, the method includes the step of sending details of the initial transactor to the electronic transaction system for purposes of setting up an initial transactor account.

In one embodiment, the method includes the step of receiving an assigned initial transactor code associated with the initial transactor account from the electronic transaction system.

In one embodiment, the method includes the step of receiving an assigned subsequent transaction code associated with the subsequent transaction from the electronic transaction system.

In another aspect the present invention may be said to broadly consist in a method of using a transaction facilitation service on an electronic transaction system on which a prior initial transaction has been completed, and against which an initial transaction code has been issued, said method comprising the steps of:
sending a subsequent transaction instruction signal to signal intention to transact in at least one subsequent item in a subsequent transaction; and
sending an initial transaction code signal associated with said initial transaction for the purposes of referencing the subsequent transaction to said initial transaction.

In one embodiment, the method includes the step of sending a subsequent interrogation signal for interrogating an item database.

In one embodiment, the method includes the step of receiving a subsequent presentation signal presenting at least one subsequent item for a transaction.

In one embodiment, the method includes the step of sending a subsequent payment signal to facilitate payment of at least part of the subsequent transaction value for payment of at least the subsequent item.

In one embodiment, the method includes the step of sending details of the subsequent transactor to the electronic transaction system for purposes of setting up a subsequent transactor account.

In one embodiment, the e method includes the step of receiving an assigned subsequent transactor code associated with the subsequent transactor account from the electronic transaction system.

In one embodiment, the method includes the step of receiving an assigned subsequent transaction code associated with the subsequent transaction from the electronic transaction system.

In one embodiment, the method comprises the step of transmitting association information to an electronic transaction provider.

In one embodiment, the association information includes one or more selected from:

at least one associated transactor;

transactions associated with an associated transactor;

transactions associated with an initial transaction code;

transactions associated with type of product; and

transactions that remain within the threshold time limit.

In one embodiment, the method comprises the step of initiating the interrogation of a transaction database based on any of the association information.

In one embodiment, the method comprises the step of selecting one or more previous transactions from a list of previous transactions associated with an associated transactor as said initial transaction.

In another aspect the present invention may be said to broadly consist in an electronic transaction system, on which transactors may transact in at least one item presented for transaction, said transaction system comprising:
a receiver for receiving electronic signals;
a transmitter for transmitting electronic signals;
a processor for processing information according to a set of instructions;
digital storage media comprising at least one or more sets of instructions adapted and configured for directing said electronic transaction system to:
   receive an initial transaction instruction from an initial transactor for transacting in at least an initial item in an initial transaction;
   assign an initial transaction code associated with the initial transaction;
   receive a subsequent transactor instruction from a subsequent transactor for transacting in at least one subsequent item in a subsequent transaction;
   receive the initial transaction code from the subsequent transactor; and credit the initial transactor.

In one embodiment, the instructions are adapted and configured for directing said electronic transaction system to present at least an initial item for transacting in to an initial transactor.

In one embodiment, the instructions are adapted and configured for directing said electronic transaction system to receive confirmation of payment for the initial item as an initial transaction.

In one embodiment, the instructions are adapted and configured for directing said electronic transaction system to present at least a subsequent item for transacting in.

In one embodiment, the instructions are adapted and configured for directing said electronic transaction system to receive confirmation of payment for the subsequent item as a subsequent transaction.

In one embodiment, the instructions are adapted and configured for directing said electronic transaction system to set up an initial transactor account with the initial transactor.

In one embodiment, the instructions are adapted and configured for directing said electronic transaction system to assign an initial transactor code to the initial transaction.

In one embodiment, the instructions are adapted and configured for directing said electronic transaction system to assign an initial transactor code associated with the initial transactor.

In one embodiment, the instructions are adapted and configured for directing said electronic transaction system to associate the initial transaction code to the initial transactor code.

In one embodiment, the instructions are adapted and configured for directing said electronic transaction system to credit the initial transactor by crediting the initial transactor account of the initial transactor.

In one embodiment, the instructions are adapted and configured for directing said electronic transaction system to receive details of a subsequent transactor.

In one embodiment, the instructions are adapted and configured for directing said electronic transaction system to assign a subsequent transactor code to the subsequent transactor.

In one embodiment, the instructions are adapted and configured for directing said electronic transaction system to set up a subsequent transactor account for the subsequent transactor.

In one embodiment, the electronic transaction system comprises an item database that contains details of items that can be bought by transactors.

In one embodiment, the electronic transaction system comprises a transactor database that contains details of registered transactors.

In one embodiment, the electronic transaction system comprises a transaction database that comprises details of previous transactions.

In one embodiment, the instructions are adapted and configured for directing said electronic transaction system to present one or more selected from the initial item and the subsequent item for transacting in over a network.

In one embodiment, the instructions are adapted and configured for directing said electronic transaction system to present one or more selected from the initial item and the subsequent item for transacting in response to an interrogation signal sent by one or more selected from the initial transactor and the subsequent transactor respectively, from a remote terminal.

In one embodiment, the interrogation signal initiates a search of the item database(s) of items for transacting in.

In one embodiment, the instructions are adapted and configured for directing said electronic transaction system to interrogate the transactor database in response to the reception of a transactor code.

In one embodiment, the electronic transaction system comprises one or more transactions databases of items that have been transacted in.

In one embodiment, the instructions are adapted and configured for directing said electronic transaction system to interrogate the transactions database in response to the reception of an initial transaction code.

In one embodiment, the instructions are adapted and configured for instructing said processor to presenting one or more selected from the initial item and the subsequent item by redirecting the initial transactor or subsequent transactor to a webpage, while identifying the redirection as coming from a provider of the electronic transaction system.

In one embodiment, the instructions are adapted and configured for directing said electronic transaction system to at least partly facilitate payment of one or more selected from the initial item and the subsequent item.

In one embodiment, the instructions are adapted and configured for directing said electronic transaction system to receive an instruction from said initial transactor for transacting in at least an initial item by receiving an instruction signal from a remote terminal.

In one embodiment, the instructions are adapted and configured for directing said electronic transaction system to receive the initial transaction code from the subsequent transactor selected from a list of previous transactions.

In one embodiment, the instructions are adapted and configured for directing said electronic transaction system to receive the initial transaction code from the subsequent transactor after presenting one or more previous transactions to the subsequent transactor for selection.

In one embodiment, the previous transactions are associated with a previous transactor.

An electronic transaction system as claimed in claim 92, wherein the previous transactor associated with the selected previous transaction is set as the initial transactor.

In one embodiment, the instructions are adapted and configured for directing said electronic transaction system to receive an instruction from the subsequent transactor to reference a presented previous transaction.

In one embodiment, the instructions are adapted and configured for directing said electronic transaction system to set the referenced previous transaction as the initial transaction.

In one embodiment, the instructions are adapted and configured for directing said electronic transaction system to receive from one or more selected from said initial transactor or said subsequent transactor, association information that can be used for interrogation of previous transactions and presented for selection by said subsequent transactor.

In one embodiment, the instructions are adapted and configured for instructing said processor to create an association between one selected from the initial transactor and the subsequent transactor and the association information.

In one embodiment, the instructions are adapted and configured for instructing said processor to interrogating a list of previous transactions for association information.

In one embodiment, the instructions are adapted and configured for instructing said processor to present one or more previous transactions to the subsequent transactor in response to the interrogation of the list of previous transactions.

In one embodiment, the instructions are adapted and configured for directing said electronic transaction system to receive payment for one or more selected from the initial item and the subsequent item(s).

In one embodiment, the instructions are adapted and configured for directing said electronic transaction system to determine a credit value to be credited to the initial transactor.

In one embodiment, the subsequent transactor of the subsequent item is the same person as the initial transactor.

In one embodiment, the instructions are adapted and configured for directing said electronic transaction system to assign a subsequent transactor code to the subsequent transactor.

In one embodiment, the instructions are adapted and configured for directing said electronic transaction system to compare one or more selected from
the date of payment of the subsequent item and
the date that the subsequent transaction instruction was received with one or more selected from
the date of payment of the initial item and
the date that the initial transaction instruction was received, to determine a time lapse.

In one embodiment, the instructions are adapted and configured for directing said electronic transaction system to compare the time lapse to one or more predetermined time lapse thresholds.

In one embodiment, the instructions are adapted and configured for directing said electronic transaction system to credit the initial transactor by an amount that is dependent on the comparison of the time lapse with the time lapse threshold(s).

In one embodiment, the instructions are adapted and configured for directing said electronic transaction system not to credit the initial transactor at all if the time lapse is more than a predetermined time lapse threshold period.

In one embodiment, the instructions are adapted and configured for instructing said processor to initiate the process of delivery of the transacted item to an address designated by the initial transactor.

In another aspect the present invention may be said to broadly consist in an electronic online retail facilitation service comprising the steps of:
selling an initial item to an initial purchaser in an initial purchase; and
crediting the initial purchaser based on a function of one or more selected from the following:
   how many subsequent purchasers subsequently purchase at least one item from the seller in subsequent transactions while referencing the initial purchase;
   the value of subsequent purchases made by subsequent purchasers in subsequent purchases; and
   the date on which the subsequent purchases are made.

In one embodiment, the credited value is a percentage of the value of the initial purchase per subsequent purchase.

In one embodiment, the method comprises registering the initial purchaser and assigning an initial purchaser code to said initial purchaser associated with their registration, the initial purchaser code for reference by the subsequent purchasers during their subsequent purchase(s) to enable the initial purchaser to be credited.

In one embodiment, the method comprises assigning an initial purchase code to the initial purchase for reference by the subsequent purchasers during their subsequent purchase(s) to enable the initial purchaser to be credited.

In another aspect the present invention may be said to broadly consist in an electronic transaction system that allocates credit to an initial transactor based on a transaction carried out by a subsequent transactor.

In one embodiment, the subsequent transactor nominates the initial transactor for allocation of credit.

For the purposes of interpretation of this specification and/or claims, where reference is made to transmitting or receiving relating to certain information, this should be construed as including the transmitting or receiving of signals indicative of such information (for example in encrypted format, binary code, etc).

In this specification where a method is described in steps, the steps should not be construed as being in chronological order, unless there is no other logical manner of interpretation of the steps.

In this specification, where reference is made to a “purchase”, “purchases” or “purchasing”, this should be construed as extending to any other applicable form of commercialisation of an item or service, including but not limited to leasing, hiring, or any suitable exchange of money for goods and/or services. The use of the term “purchase” is intended as an aid to understanding the invention, and is not meant as a limitation on the nature of the transaction.

In this specification, where reference is made to the term “retail”, this should be construed as referring generally to any transactions (including but not limited to purchase as defined above, sale, hire or lease of goods or services), regardless of whether they are made to, or with, the public, and applies to transactions at any stage of the distribution chain, including but not limited to wholesale, retail, sale to/from manufacturer, or raw material purchase.

In this specification, where reference is made to the term “credit”, this should be construed as referring generally to any transactions where value is accrued to the person being credited, and includes payment of money in physical or electronic form, granting of a rebate, promissory notes, the accrual of credit in an account without immediate reimbursement, or any similar accrual of value to the person or entity being credited.

In this specification, where reference is made to the term “providing” or the “provision” of a service or a transaction, this shall be construed as providing the steps listed to at least partially facilitate the service or transaction.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.)

### BRIEF DESCRIPTION OF THE DRAWINGS

The invention will now be described by way of example only and with reference to the drawings in which:

FIG. 1: shows a flow chart showing a method of providing a retail service used by an initial purchaser and a subsequent purchaser;

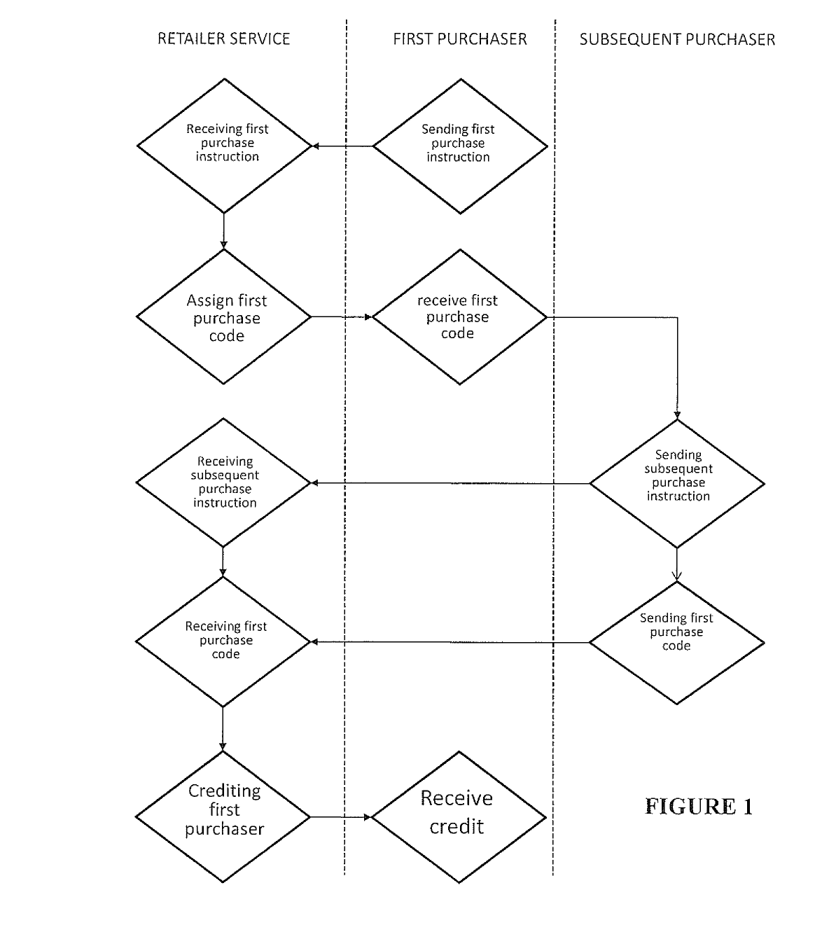

FIG. 2: shows a flow chart showing a method of providing a retail service used by the same purchaser as both initial purchaser and subsequent purchaser;

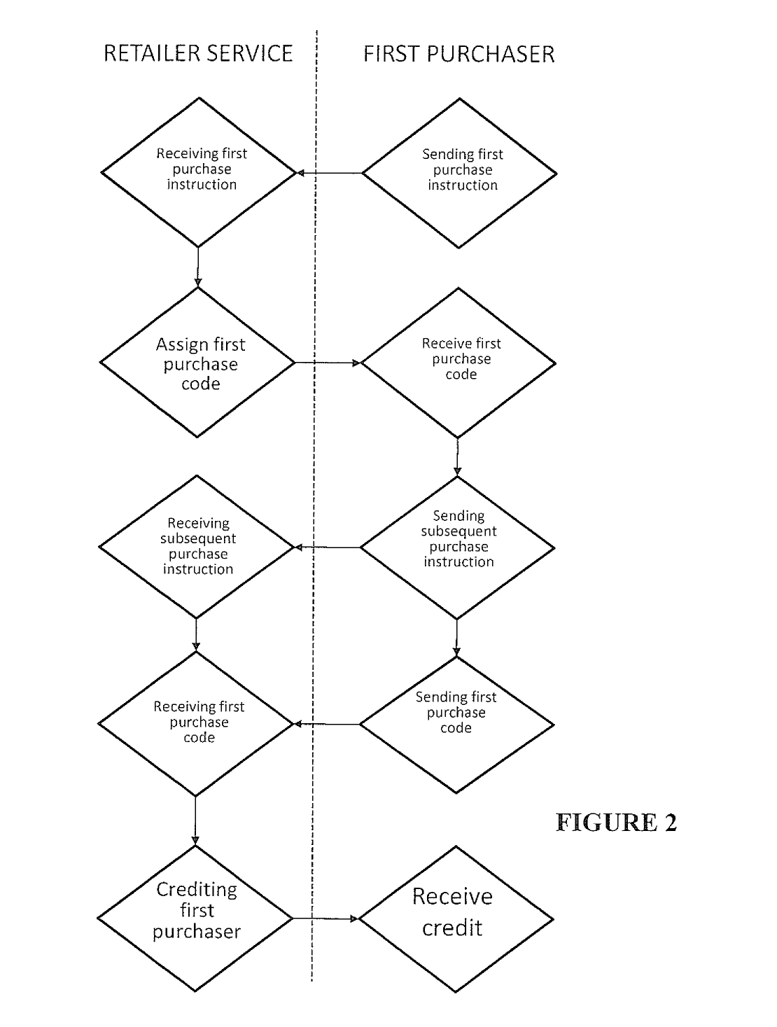

FIG. 3: shows a flow chart showing a method of providing a retail service used by the same purchaser as both initial purchaser and subsequent purchaser;

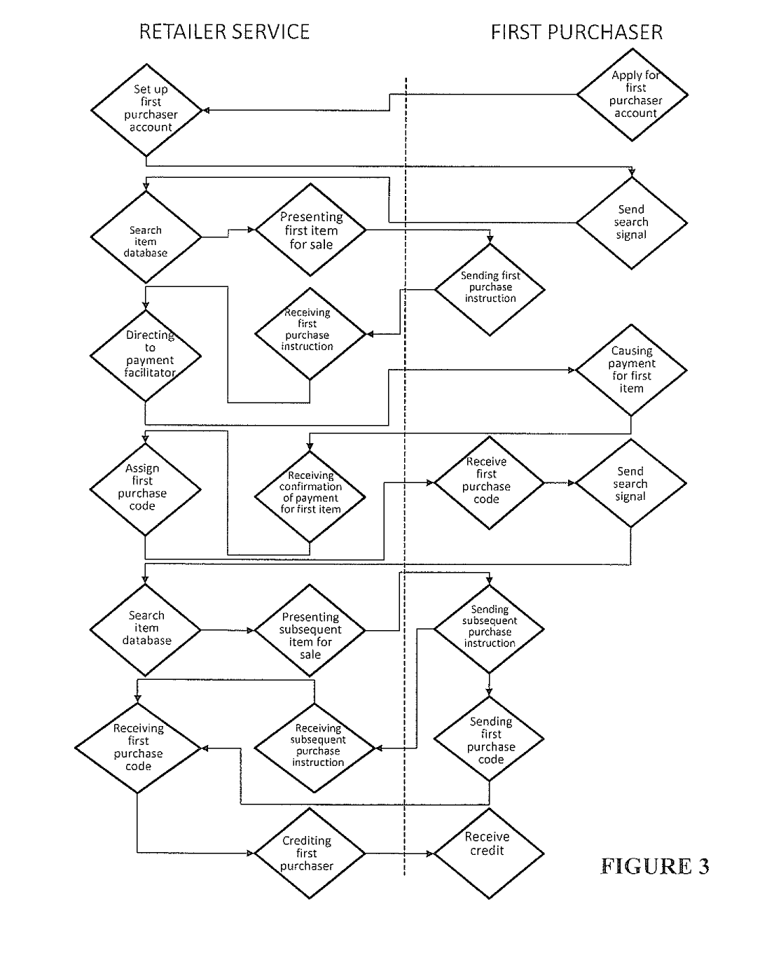

FIG. 4: shows a flow chart showing a method of providing a retail service used by the same purchaser as both initial purchaser and subsequent purchaser, as well as another purchaser involved as s subsequent purchaser;

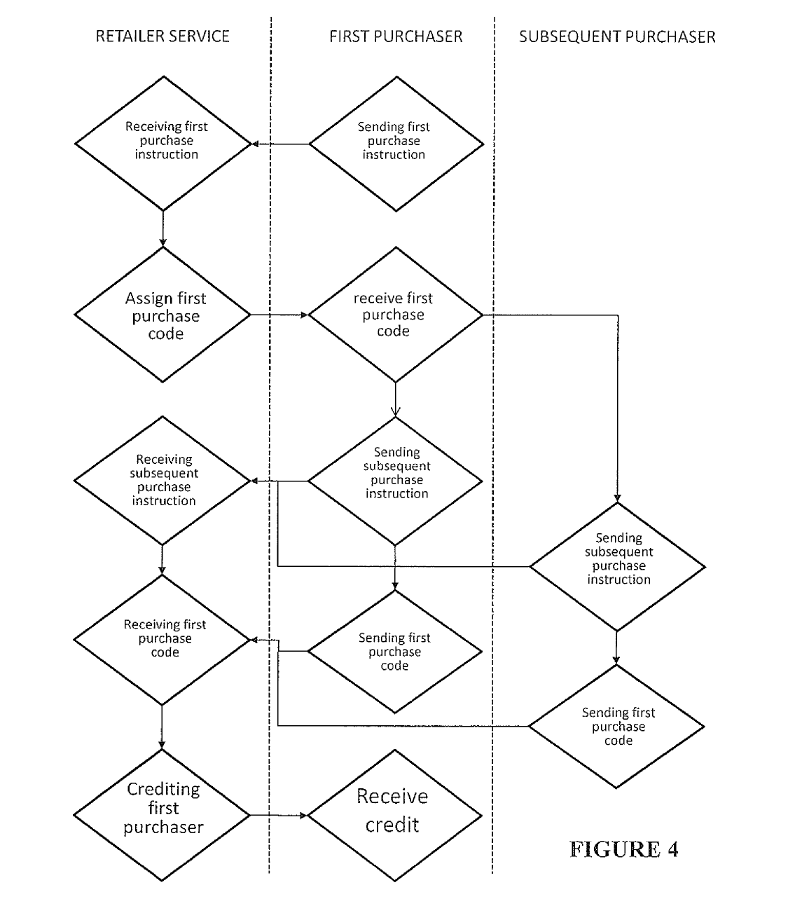

FIG. 5: shows an electronic retail system;

FIG. 6: shows a flow chart showing steps taken by a subsequent purchaser and a retail service provider as part of a method of providing an electronic retail service; and

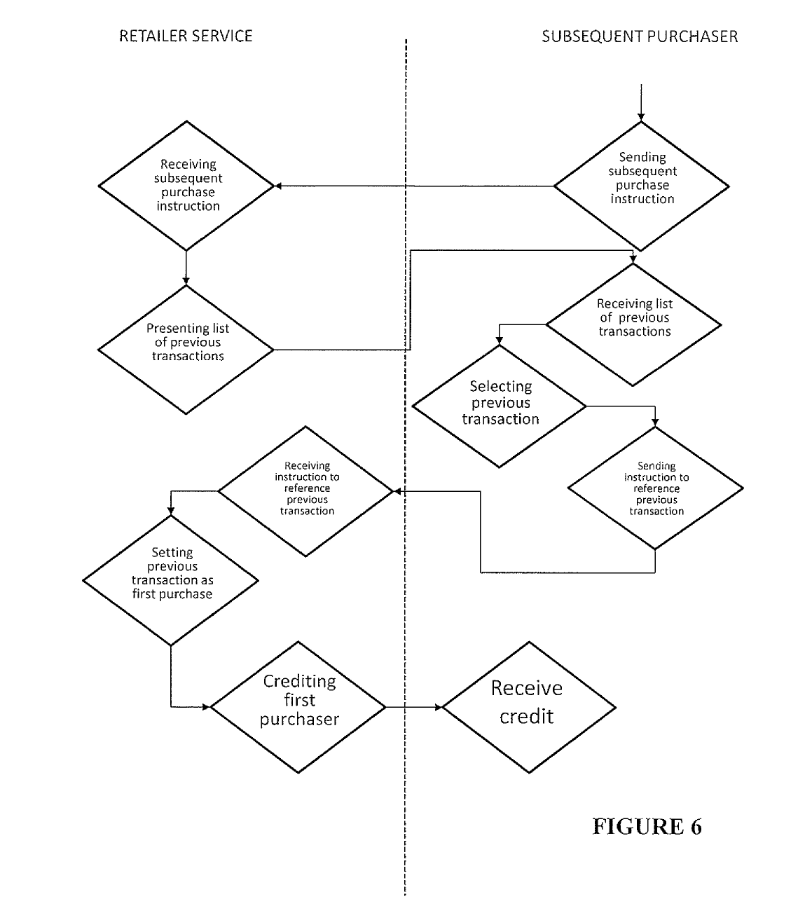

FIG. 7: shows a flow chart showing steps taken by a retail service provider in determining credit accruing to an initial purchaser.

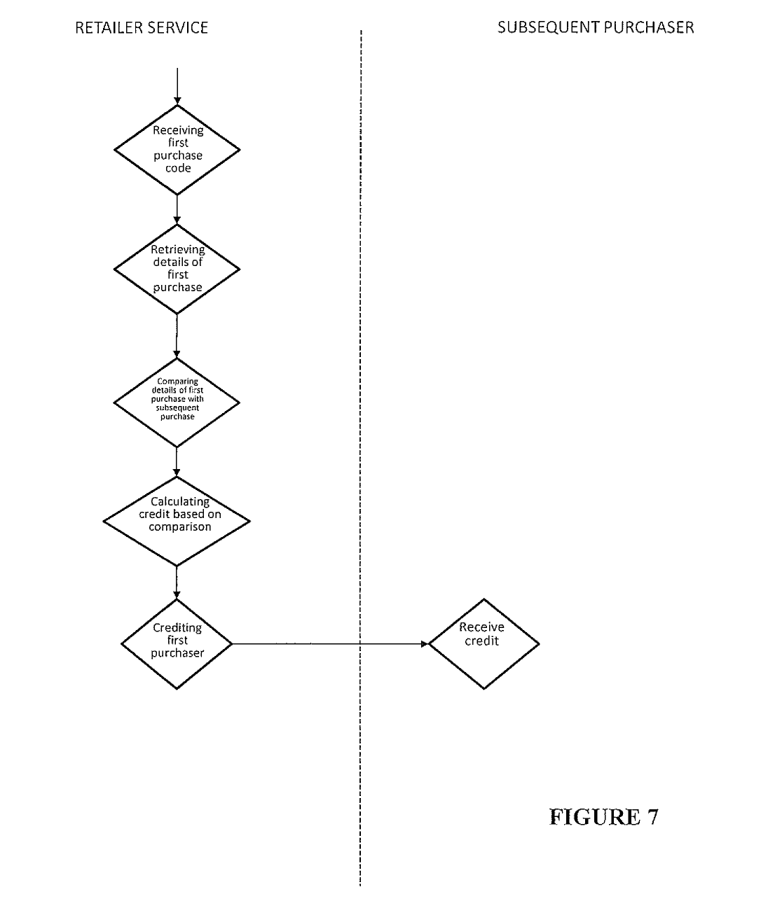

### DETAILED DESCRIPTION OF THE PREFERRED EMBODIMENT(S)

With reference to the above drawings, in which similar features are generally indicated by similar numerals, an electronic retail system according to one aspect of the invention is generally indicated by the numeral 1000, and a method of providing or facilitating a retail service and/or operation therefor is described below.

In one embodiment now described, there is provided an electronic system for facilitating the provision of a transaction. The transactions that can be facilitated could include transactions of any nature, such as purchasing, hiring, leasing or any other suitable exchange of money for goods and/or services. It will be appreciated that each transaction type has specific legal requirements that identify it as that transaction type, which legal requirements will need to be satisfied in order to complete the transaction. It is regarded as being within the scope of this specification to identify and require individual steps required to complete that transaction type, However, for the purposes of clarity of explanation, this specification will focus specifically on the purchase of goods. Where other transaction types are envisaged, then the steps required to complete them are envisaged as being included. The use of the term “purchase” is intended as an aid to understanding the invention, and is not meant as a limitation on the nature of the transaction that may be carried out by the electronic system for facilitating the provision of a transaction.

Further, the system and method is explained below with respect to its use in a retail environment. However, it is envisaged that the system and method can be used in for transactions carried out at any stage of the distribution chain, including but not limited to wholesale, retail, sale to/from manufacturer, or for transactions related to raw material.

In this description, the electronic system facilitating the provision of a transaction is embodied as an electronic retail system 1000, on which purchasers (not shown) can purchase at least one item (not shown) that is presented, made available or offered for sale online by an electronic retail service provider (not shown). In a preferred embodiment, any types of goods may be offered for sale on the electronic retail system 1000, although it is envisaged that classes of goods or services may be offered separately.

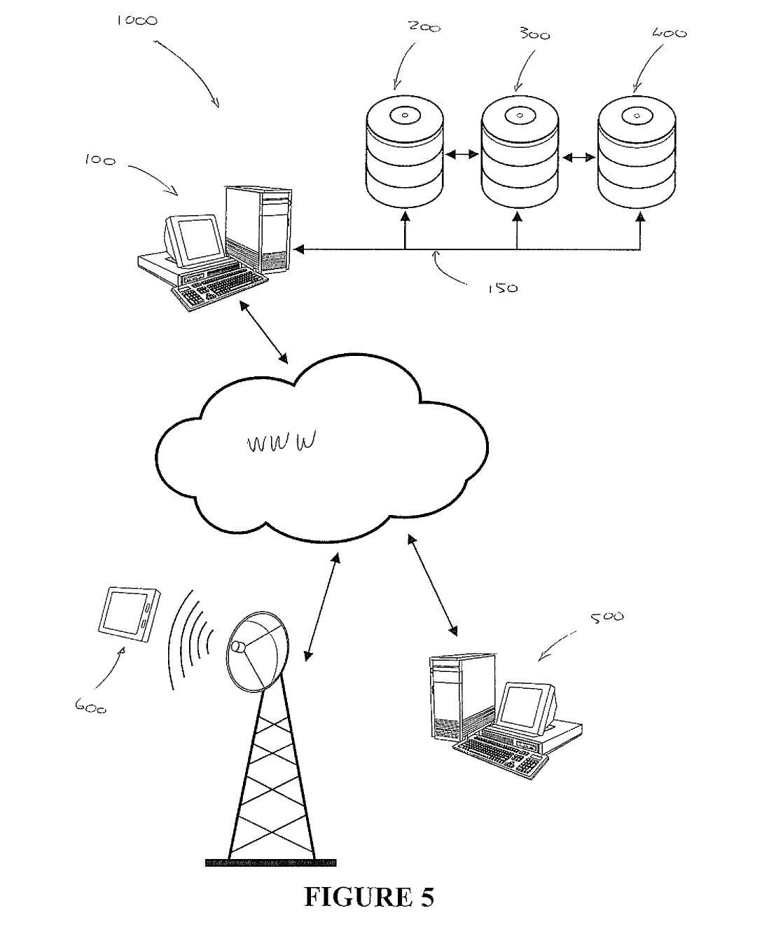

The retail system 1000 comprises at least one processor (not shown) for processing information according to a set of instructions, and digital storage media (not shown) for storing instructions, preferably in the form of software (not shown). It is envisaged that the digital storage media could be any form of storage media such as a hard disk, flash disk memory, magnetic tape, or any other suitable storage media on which software can be stored. It is envisaged that not all of the software may be stored together on a single digital storage medium. In a preferred embodiment, the processor and digital storage media are embodied by a computer 100, for example a server that is connected to an electronic database. The computer 100 is attachable to a network. It is envisaged that in a preferred embedment, the network can be a Local Area Network (LAN) 150, and the LAN 150 is connected to the Internet (shown by reference letters WWW in FIG. 5), either directly, or via the computer 100.

The instructions in the form of software are adapted and configured for directing operation of the processor to carry out calculations, comparisons and determinations as may be required, for the carrying out of the steps described below. The term adapted and configured when used in regards to the instructions means that they are written in suitable programming language and compiled in a format for being recognised and acted on by a processor or machine that is capable of following software instructions. In turn remote terminals, possibly in the form of home computers 500, or mobile electronic devices 600 (preferably web-enabled mobile devices, and wirelessly enabled mobile devices that are connectable to networks such as the Internet such as laptops, mobile phones, and tablet devices) will be able to connect to the computer 100 via the Internet.

The electronic retail system 1000 further comprises a receiver (not shown) for receiving signals from a remote terminal operated by a remote user, and a transmitter (not shown) for transmitting signals to a remote terminal for display to a remote purchaser. In a preferred embodiment, both the receiver and the transmitter are envisaged as being a network card (not shown), together with its associated hardware and software, installed in and associated with the computer 100, that enables the processor to transmit signals to and receive signals from the LAN and/or Internet.

The software is configured and adapted for instructing the processor (or plurality of processors) to carry out steps as described below, to enable the functioning of an electronic retail service. Unless otherwise stated, or it logically could not be construed any other way, where reference is made to a particular step being carried out, it should be read as having been enabled by the software being configured and adapted to direct the processor to carry out the step.

The electronic retail system 1000 further comprises one or more databases that are searchable. One item database 200 contains details of items that can be bought by purchasers over the Internet. This item database 200 includes, but is not limited to, details of the items to be bought, including any one or more of the following:
item name;
description of the item;
nature of the item;
price of the item;
colour of the item;
discounts that may be relevant to that item;
supplier of the item; and
minimum number of items to be sold together.

It is envisaged that in a preferred embodiment, the electronic retail system 1000 will also include another purchaser database 300 that contains details of registered purchasers of the electronic retail system 1000. Details of registered purchasers include any information relevant to the user or accounts registered by a user, and include, but are not limited to, any one or more of the following:
name(s) of the purchaser;
user names/handle/nicknames of the purchaser;
address of purchaser;
purchaser's payment facilitation details (such as credit card number, Paypal account number, etc);
purchaser's contact details;
an associated purchaser code
past purchases made by the purchaser;
purchase codes associated with each of the past purchases made by the purchaser.

Purchasers could also on registration, or at any other time, submit association information for themselves. Association information comprises any one or more selected from:
associated purchasers (which will typically be friends of theirs);
transactions associated with associated purchasers;
transactions associated with an initial purchase code;
transactions associated with type or nature of products; and
transactions that remain within the threshold time limit

The use of the association information is described below.

It is envisaged that purchasers will initially register on the electronic retail system, to set up a purchaser account, submitting details of themselves as above. On registering to form an account, each purchaser will receive a purchaser code associated with their account.

It is also envisaged that in one preferred embodiment, the electronic retail system 1000 can also include a transaction database 400 that contains details of previous purchases that may have been purchased from the retail service provider or their associated suppliers or partners. The transaction database 400 can contain information including, but not limited to:
a purchase code associated with that purchase;
the purchaser code of the purchaser.
item sold,
item code;
items details;
transaction value;
tax amount on transaction;
other transaction details (for example number and or value of
auction bids received)
date and/or time of sale;
purchaser details; and
purchaser's association information.

The purchaser code allocate to each purchaser (on registration of their account) can be associated with each purchase made by that purchaser, to allow for the convenient retrieval of purchases associated with that purchaser by interrogation of the transaction database.

The instructions stored on the digital storage media are configured and adapted for directing one or more processors to perform a series of steps, as will be described below.

In a preferred embodiment, the software will be configured and adapted to transmit information for the presentation of a website to remote users over the Internet (although other networks are also envisaged as being possible). The website will allow for the presentation of items that may be purchased.

In one preferred embodiment, information about the items for purchase will be held in the item database 200, however, it is envisaged that in another embodiment, the website may be configured and adapted to allow interrogate databases of partners of the electronic retail service provider and receive information about items for sale from the partners. It is envisaged that when the interrogation of the databases of the partners is carried out by the electronic retail system, preferential pricing on those items will be offered by the partners. In this way, the electronic retail system website acts as a “channel” to other websites of partners. In any event, at least one item is presented to a potential purchaser for purchase.

In one preferred embodiment, the website will offer a search capability to the remote potential purchasers, to allow them to search for items that they want to buy (either on the item database 200 or the partner's databases). Potential purchasers will input a search term with which the item database 200 is to be interrogated, and transmit the search term to the electronic retail system 1000. The search term will then be used by the electronic retail system 1000 to search or interrogate the item database 200, and return a result. The result will then be transmitted to the remote terminal for display to the potential purchasers.

The potential purchasers can then select an item for purchase. This may be from a list of potential items if the result of the interrogation using the search term reveals more than one result.

Once the item is selected, this transmits a signal from the remote terminal, which will be received by the electronic retails system 1000, indicating that the purchase is to be initiated. In one preferred embodiment, the electronic retails system 1000 will then transmit signals to the remote terminal to facilitate payment for the item by the potential purchasers.

The facilitation of payment by the potential purchasers could be by enabling receipt of direct payment from the purchaser's bank or financial agent, or to direct the potential purchasers to a payment facilitation service, such as a credit card facility or PayPal™. Typically, once payment has been made or electronically facilitated, a signal confirming payment will be received by the electronic retail system 1000.

Once payment has been confirmed, the purchaser is preferably requested to enter an input which indicates that they want to reference a previous or earlier purchase that has been carried out as a first or initial transaction.

For the purpose of explanation of the processes carried out by the electronic retail system 1000, if no previous transaction is referenced, then the present purchase by the purchaser is to be regarded as an “initial purchase” in an “initial transaction”, and the purchaser is regarded as a “initial purchaser”. If a previous transaction is referenced, then the present purchaser is regarded as a “subsequent purchaser” of a “subsequent purchase” in a “subsequent transaction”.

If no previous transaction is referenced, then the present purchase by the purchaser is set by the electronic retail system 1000 as an “initial purchase” in an “initial transaction”.

Every initial purchase is preferably automatically assigned an initial purchase code associated with that transaction by the electronic retail system 1000. In one preferred embodiment, every completed transaction (whether it is an “initial purchase” or a “subsequent purchase” as detailed below) is allocated a purchase code associated with that transaction. In one embodiment, purchase codes associated with each transaction are then stored in association with a purchaser on the purchaser database 300.

Typically, it is envisaged that when a purchase is an initial purchase and part of an initial transaction, the completion of that transaction (for example by receiving confirmation of payment) will not result in any further transactional steps (such as steps for determining credit accrual for any purchasers) being carried out, except possibly for the storage of the transaction details in the transaction database, and the storage of the transaction and/or linking of the initial transaction against the initial purchaser's account.

The electronic retail system 100 will then initiate the process of delivery of the purchased item to an address designated by the initial purchaser.

If, however, on confirmation of payment, the purchaser indicates that they want to reference a previously or earlier transaction as a “initial transaction”, then a different set of steps is initiated.

If an earlier or previous transaction is to be referenced, then the previous transaction is set as a “initial transaction”, and the present transaction is set as a “subsequent transaction”.

The previous transaction to be referenced as an initial transaction could be any transaction that has been carried out previously. The initial transaction could have been carried out by the same purchaser, or by any other purchaser. The initial transaction could be limited to similar goods or services, or to any other transactions associated with the association information.

In one embodiment, the electronic retail system 1000 will preferably present a set of previous transactions for selection by the present purchaser of one (or more) as an initial transaction. In one embodiment, all and/or any previous transactions associated with a particular purchaser (or purchasers) could together be referenced as initial transactions.

In one embodiment, the set of previous transactions presented for selection by the present purchaser may be found by interrogating one or more of the databases for information that may be input by the present purchaser at the time as a search term.

In another embodiment, previous transactions that are presented to the remote user may be found by the electronic retail system by searching any of the databases based on the association information provided by that remote user, or by other remote users.

For example, two users may have registered purchaser accounts with the electronic retail system 1000, and one or more of them may have submitted association information linking each other (for example as “friends”). This association can be used automatically by the electronic retail system, to retrieve previous transactions associated with that friend, or the total value of transactions previously carried out by that friend.

In one embodiment, when the remote user makes a purchase, the electronic retail system uses the association information provided by that remote user to interrogate the transaction database for transactions related to an associated purchaser, and retrieves all previous purchases made by that associated purchaser to be sent to the remote user and displayed as a list of hyperlinks. This interrogation may be modified by other factors, such as a nature and type of goods, time lapse since the pervious purchase, value of the previous purchase, etc. It is envisaged that association information could be amended, changed or updated by the remote user or the service provider at any time by editing the information in their account settings, or by editing allowable interrogations.

In one embodiment, the previous transactions that are presented will be related to associated persons (for example their friends, spouse, or even themselves) that have accounts that are associated with the current purchaser.

Whether the interrogation carried out by the electronic retail system 1000 is based on the association information, or based on any information inputted by the present purchaser, will retrieve a list of transactions that meet the search criteria. These transactions are then transmitted to the remote user for display on their remote terminal, such as their home computer or mobile electronic device. They can then select the transaction or transactions to be referenced as initial transactions.

It will be appreciated that the process of searching for items, selecting items and paying for or facilitating payment for items can be identical regardless of whether the purchaser is an initial purchaser or a subsequent purchaser.

If a previous transaction is referenced (for example by selecting a hyperlink forma list of hyperlinks), then that selected previous transaction (or set of transactions) is set as a “initial transaction” by the electronic retail system. The selection of a previous transaction from a list of previous transactions, by way of a mouse click on a hyperlink for example, transmits a signal indicating that a particular previous transaction is to be set as an initial transaction (arising from an initial purchase by an initial purchaser), and causes the electronic retail system 1000 to reference and/or receive an initial purchase code or identifier indicative of the initial transaction (generally for the purpose of referencing the transaction on a database to retrieve transaction details).

The transaction code or identifier is then used to interrogate the transaction database 400 for details of the initial transaction. The instructions are then configured and adapted to instruct the processor to use the details of the initial transaction in a process of determining whether, and how much, credit is to be accrued to the initial purchaser

When an initial transaction is referenced by a subsequent purchaser in a subsequent transaction, then a process of determination of credit accruing to the initial purchaser is initiated.

As a base process, the electronic retail system 1000 will preferably compare the number and details of the subsequent transaction(s) to details of the referenced initial transaction(s). In one embodiment, it is envisaged that the transaction value of the subsequent transaction will be compared to a predetermined comparison amount. In one embodiment, the predetermined comparison amount could be the value of the referenced initial transaction. In another embodiment, the predetermined comparison amount could be a percentage of the value of the initial transaction.

The electronic retail system could compare other details of the initial and subsequent transactions. In one embodiment, one or more of the date of receiving the instruction to purchase the initial purchase, or date of payment for the initial purchase, could be compared to the date of receiving the instruction to purchase the subsequent purchase, or date of payment for the subsequent purchase, to determine a time lapse. The time lapse could be compared to one or many predetermined time lapse thresholds. The accrual of credit to the initial purchaser could be made dependent on whether a particular time lapse threshold has been exceeded (for example, no credit is accrued if more than two months has passed). In another embodiment, amount of credit accrued could be made dependent on the time lapse (for example, the longer the time lapse is, the less credit is accrued to the initial purchaser). This could involve having daily time lapse threshold, or weekly time lapse thresholds.

In one embodiment, the time lapse threshold would preferably be between 1 and 8 months and more preferably between 2 and 4 months.

In one embodiment, no credit would accrue to the initial purchaser from subsequent purchases carried out two or more months after the initial purchase.

The determination of the credit accruing to the initial purchaser could be carried out in many ways. In one embodiment, a predetermined amount of credit could be accrued to the initial purchaser for each subsequent transaction. In another embodiment a predetermined amount of credit could be accrued to the initial purchaser for each subsequent transaction that has a value in excess of a predetermined threshold amount. In another embodiment a predetermined amount of credit could be accrued to the initial purchaser for each subsequent transaction that has a value in excess of a predetermined percentage of the initial purchase value.

In another embodiment credit could be accrued to the initial purchaser as a percentage of the value of each subsequent transaction. In either of these embodiments, a predetermined threshold value may be required to be purchased by a predetermined number of subsequent purchasers (for example five people making subsequent purchases equal to the initial purchase) before credit is accrued to the initial purchaser.

A threshold on the maximum amount of credit receivable by the initial purchaser may be set, either as a percentage of the value of the initial transaction (e.g. 100% of the value of the initial transaction), or as an absolute limit (e.g. $2000). Once the threshold set for credit accrual has been reached, the transaction may be prevented from being referenced further by subsequent purchasers.

It should be appreciated that the term “credit” need not refer to monetary value. For example, the initial purchaser could be credited with an item, such as the item that they originally purchased, or an equivalent thereof, or an item of equivalent value. While the term credits is generally used to relate to a monetary amount that may be tallied or paid electronically, it will be appreciated that many different ways of crediting a transactor may be possible. Examples of these include payment of money in physical or electronic form, the granting of a rebate, promissory notes, the accrual of credit in an account, or any similar accrual of value.

Typically, once credit has been accrued to an initial purchaser, which will be carried out either as direct payment to them or their bank electronically, or reflect as credit in their purchaser account, then a notification signal will preferably be transmitted to the initial purchaser of the credit accrued to them, as well as details of the transactions that resulted in the credit being accrued to them. In this way, the initial purchaser will be made aware of the subsequent purchasers referencing their transactions, to incentivise them to in turn reference the subsequent purchaser or their transactions in later subsequent purchases.

In the embodiments described, credit is accrued to the initial purchaser by the initiation of one or more subsequent purchases. In this way subsequent purchases by the initial purchaser are incentivised through the social expectation of paying back a favour to the subsequent purchaser. If purchasers are organised and supportive of each other, substantial credit may be accrued in an ongoing manner. Credit of monetary value would typically be for use by the initial purchaser for use in their next purchase transaction—further incentivising the purchasers to buy from the retail service provider, while simultaneously allowing the initial purchaser (if they wish) to then reference the subsequent transaction as an initial transaction, so that credit is accrued in return to the subsequent purchaser.

It should be noted that the process of credit accrual need not necessarily operate on a “single tier” referral system. A transaction can be a subsequent (e.g. a “second”) transaction for the purposes of determining credit accruing to the initial purchaser of the initial transaction to which it refers, but the same transaction may also be referred to as a “initial transaction” for the purposes of accruing credit to that subsequent purchaser if say a third transaction is carried out and refers to the “second” transaction. In this way, an initial purchaser to whom credit has been accrued by a subsequent purchaser referring to their initial transaction, can repay the favour by referring to the subsequent or second transaction (making it in turn an initial or “initial transaction”) for one of their subsequent (for example third) transactions. In this way referrals can be spread over multiple tiers on an ongoing basis in a perpetual tiering system.

In one embodiment, any credit determined to have been accrued to the initial purchaser could be conveyed to the initial purchaser by crediting the initial purchaser's account for use at a later date, or by electronic transfer of funds to their bank account. In such a scenario, it is envisaged that the credit would not be allocated or linked to a specific previous transaction (which could limits the value of the credit allocated). Instead the credit would be allocated and linked to the user, to be paid to them or by crediting their account for use in as yet uncompleted transactions.

It is envisaged that the referral to previous transactions to make them initial transactions can also be utilised to stimulate charity donations, for example if the associated information includes a name of a preferred charity association. Where the credit accrued on a particular previous initial transaction by the charity amounts to 100% of its value, then the charity would effectively be getting paid the value of their goods in that initial transaction (even though in some embodiments the value may only be usable against their next transaction).

In another embodiment, if no initial transaction is referenced, credit that may have otherwise accrued can be allocated by the electronic transaction system to previous purchasers on a “first purchased, first paid” basis, where those purchases that were made earliest in time are allocated the credit until a threshold value (such as the full transaction value or a percentage thereof) has been reached.

It will be appreciated that the levels of sophistication offered by such an electronic retail system 1000 could vary substantially. In one embodiment, the system could be a standalone system that offer s single tier system offered by as single retailer of a single type or nature of goods or services, in which the initial purchaser buys one item, receives a purchase code, and lets their friends know about their purchase code, so that if they buy the same goods, they can reference the initial purchaser's initial purchase, and cause him to be credited buy the electronic retail system. The amount of credit accrued could be as simple as receiving 100% discount if 5 subsequent purchasers each buy goods of the same nature of an equal value as the initial purchase.

The electronic retail system 1000 could also be implemented into existing systems, such as Facebook™ in a significantly more complex manner, where by friend associations could serve as association information, and retailers could each have retail sites accessible through the electronic retail system 1000, to which potential purchasers may be redirected, and which can operate on a ‘perpetual tiering’ system, where a transaction can be a subsequent transaction in that it references previous transactions as initial transactions, but also can be an initial transaction that is referenced by subsequent transactions carried out by later purchasers (which purchasers may even be the same purchasers).

In such a system, a purchase code would be assigned for each subsequent transaction, which purchase code may be referenced by subsequent purchasers in even later transactions. It is envisaged that the referencing of the purchase code would be carried out in a similar format and manner as that described above for the initial transaction.

The electronic retail system 1000 described above allows for the operation of a method of providing a retail service by a seller or retail service provider, by transacting at least an initial item to an initial purchaser in an initial transaction, and crediting the initial purchaser based on at least one or more considerations. These considerations are:
how many subsequent purchasers subsequently purchase at least one item in subsequent transactions while referencing the initial transaction;
the value of subsequent purchases made by the subsequent purchasers; and
the date on which the subsequent transactions are made.

The electronic retail system 1000 described above incentivises purchasing through it. The purchasers will effectively experience reduced retail prices after having received credit from subsequent purchases. Retailers will be incentivised to sell their goods and items through the electronic retail system 1000 as it will result in increased volume of sales for them (although at lower margins). In this way, it is expected that the electronic retail system will result in increased value for consumers, and an effective sales outlet for retailers.

It will be appreciated that in contrast to the prior art, the present invention means that an initial or initial purchaser does not rely on their own prior transaction history to affect the credit accrued to them on the initial transaction, but will rely on subsequent actions and transaction by themselves or others to affect the level of credit accrued retrospectively on that initial transaction.

In this way, the present convention allows for a completely different set of incentives to transact to come into play. Not the least of these will be the social pressure on subsequent transactor to repay favours done by the initial transactor in nominating an even earlier transaction of the subsequent transactor. Further, by mutual cooperation, a plurality of transactors can obtain substantial discounts consistently, and without having to rely on chance.

It will be appreciated that while the electronic transaction system described above has been described with respect to a an “offer and acceptance” type transaction system, it could also be utilised in relation to an “auction type” transaction system, for example where a percentage of the transaction fee of an auction that has been won, is granted as credit to the referenced winner of a previous auction.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

What is claimed is:

1. A method of facilitating an online transaction, enabled by an electronic transaction system through a transaction service provider, said method comprising the steps of:
a) receiving an initial transaction instruction from an initial transactor for transacting in at least an initial item in an initial transaction;
b) assigning an initial transaction code associated with the initial transaction;
c) receiving a subsequent transaction instruction from a subsequent transactor for transacting in at least one subsequent item in a subsequent transaction;
d) receiving notification of the initial transaction code from the subsequent transactor; and
e) crediting the initial transactor.

2.-11. (canceled)

12. The method of facilitating an online transaction as claimed in claim 1, wherein the step of crediting the initial transactor comprises the step of setting up an initial transactor account with the initial transactor, and crediting the initial transactor account of the initial transactor.

13.-19. (canceled)

20. The method of facilitating an online transaction as claimed in claim 1, wherein the method includes the step of presenting at least a subsequent item for purposes of transacting in that subsequent item; wherein the step of presenting one or more items selected from the initial item and the subsequent item is by redirecting the initial transactor or subsequent transactor to a webpage, while identifying the redirection as coming from the transaction service provider.

21.-22. (canceled)

23. The method of facilitating an online transaction as claimed in claim 1, wherein the step of receiving the initial transaction code from the subsequent transactor includes the step of presenting one or more items selected from previous transactions and previous transactors to the subsequent transactor for selection as an initial transaction and/or initial transactor respectively.

24. The method of facilitating an online transaction as claimed in claim 1, wherein the method comprises the step of receiving association information from one or more items selected from said initial transactor and said subsequent transactor.

25. The method of facilitating an online transaction as claimed in claim 5, wherein the association information includes one or more selected from:
e) associated transactors;
f) transactions associated with the associated transactors;
g) transactions associated with the initial transaction code;
h) transactions associated with type of product; and
i) transactions that remain within the threshold time limit.

26. The method of facilitating an online transaction as claimed in claim 24, wherein the method comprises the step of creating an association between one selected from the initial transactor and the subsequent transactor and the association information.

27. The method of facilitating an online transaction as claimed in claim 24, wherein the step of presenting one or more previous transactions to the subsequent transactor includes the step of interrogating at least part of the association information for a list of previous transactions.

28. The method of facilitating an online transaction as claimed in claim 27, wherein the step of presenting one or more previous transactions to the subsequent transactor includes the step of presenting one or more previous transactions to the subsequent transactor in response to the interrogation of at least part of the association information for previous transactions.

29.-40. (canceled)

41. A method of using a transaction service, enabled by an electronic transaction system, said method comprising the steps of:
a) sending an initial transaction instruction to transact in at least one initial item in an initial transaction;
b) being assigned an initial transaction code associated with the initial transaction; and
c) being credited by said electronic transaction system in the event that a subsequent transaction transacting in one or more subsequent items is initiated, and the initial transaction code is referenced.

42.-53. (canceled)

54. A method of using a transaction facilitation service on an electronic transaction system on which a prior initial transaction has been completed, and against which an initial transaction code has been issued, said method comprising the steps of:
a) sending a subsequent transaction instruction signal to signal intention to transact in at least one subsequent item in a subsequent transaction; and
b) sending an initial transaction code signal associated with said initial transaction for the purposes of referencing the subsequent transaction to said initial transaction.

55.-60. (canceled)

61. The method of using a transaction facilitation service as claimed in claim 54, wherein the method comprises the step of transmitting association information to an electronic transaction provider.

62. The method of using a transaction facilitation service as claimed in claim 54, wherein the association information includes one or more selected from:
a) at least one associated transactor;
b) transactions associated with an associated transactor;
c) transactions associated with an initial transaction code;
d) transactions associated with type of product; and
e) transactions that remain within the threshold time limit.

63. The method of using a transaction facilitation service as claimed in claim 61, wherein the method comprises the step of initiating the interrogation of a transaction database based on any of the association information.

64. The method of using a transaction facilitation service as claimed in claim 63, wherein the method comprises the step of selecting one or more previous transactions from a list of previous transactions associated with an associated transactor as said initial transaction.

65. An electronic transaction system, on which transactors transact in at least one item presented for transaction, said transaction system comprising:
a) a receiver for receiving electronic signals;
b) a transmitter for transmitting electronic signals;
c) a processor for processing information according to a set of instructions;
d) digital storage media comprising at least one or more sets of instructions adapted and configured for directing said electronic transaction system to:
(i) receive an initial transaction instruction from an initial transactor for transacting in at least an initial item in an initial transaction;
(ii) assign an initial transaction code associated with the initial transaction;
(iii) receive a subsequent transactor instruction from a subsequent transactor for transacting in at least one subsequent item in a subsequent transaction;
(iv) receive the initial transaction code from the subsequent transactor; and
(v) credit the initial transactor.

66.-69. (canceled)

70. The electronic transaction system as claimed in claim 65 wherein the instructions are adapted and configured for directing said electronic transaction system to set up an initial transactor account with the initial transactor.

71. The electronic transaction system as claimed in claim 65 wherein the instructions are adapted and configured for directing said electronic transaction system to assign an initial transactor code to the initial transaction.

72. The electronic transaction system as claimed in claim 71, wherein the instructions are adapted and configured for directing said electronic transaction system to assign an initial transactor code associated with the initial transactor.

73. The electronic transaction system as claimed in claim 65, wherein the instructions are adapted and configured for directing said electronic transaction system to associate the initial transaction code to the initial transactor code.

74. (canceled)

75. The electronic transaction system as claimed in claim 65, wherein the instructions are adapted and configured for directing said electronic transaction system to receive details of a subsequent transactor.

76. The electronic transaction system as claimed in claim 65, wherein the instructions are adapted and configured for directing said electronic transaction system to assign a subsequent transactor code to the subsequent transactor.

77. The electronic transaction system as claimed in claim 65, wherein the instructions are adapted and configured for directing said electronic transaction system to set up a subsequent transactor account for the subsequent transactor.

78. (canceled)

79. The electronic transaction system as claimed in claim 65, wherein the electronic transaction system comprises a transactor database that contains details of registered transactors.

80. The electronic transaction system as claimed in claim 65, wherein the electronic transaction system comprises a transaction database that contains details of previous transactions.

81.-83. (canceled)

84. The electronic transaction system as claimed in claim 79, wherein the instructions are adapted and configured for directing said electronic transaction system to interrogate the transactor database in response to the reception of a transactor code.

85. (canceled)

86. The electronic transaction system as claimed in claim 80, wherein the instructions are adapted and configured for directing said electronic transaction system to interrogate the transactions database in response to the reception of an initial transaction code.

87. The electronic transaction system as claimed in claim 65, wherein the instructions are adapted and configured for instructing said processor to present one or more selected from the initial item and the subsequent item by redirecting the initial transactor or subsequent transactor to a webpage, while identifying the redirection as coming from a provider of the electronic transaction system.

88.-89. (canceled)

90. The electronic transaction system as claimed in claim 71 wherein the instructions are adapted and configured for directing said electronic transaction system to receive the initial transaction code from the subsequent transactor selected from a list of previous transactions.

91. The electronic transaction system as claimed in claim 90, wherein the instructions are adapted and configured for directing said electronic transaction system to receive the initial transaction code from the subsequent transactor after presenting one or more previous transactions to the subsequent transactor for selection.

92. The electronic transaction system as claimed in claim 65, wherein the previous transactions are associated with a previous transactor.

93. The electronic transaction system as claimed in claim 92, wherein the previous transactor associated with the selected previous transaction is set as the initial transactor.

94. The electronic transaction system as in claim 94, wherein the instructions are adapted and configured for directing said electronic transaction system to receive an instruction from the subsequent transactor to reference a presented previous transaction.

95. The electronic transaction system as claimed in claim 94, wherein the instructions are adapted and configured for directing said electronic transaction system to set the referenced previous transaction as the initial transaction.

96. The electronic transaction system as claimed in claim 90, wherein the instructions are adapted and configured for directing said electronic transaction system to receive from one or more selected from said initial transactor or said subsequent transactor, association information that can be used for interrogation of previous transactions and presented for selection by said subsequent transactor.

97. The electronic transaction system as claimed in claim 96, wherein the instructions are adapted and configured for instructing said processor to create an association between one selected from the initial transactor and the subsequent transactor and the association information.

98. The electronic transaction system as claimed in claim 96 wherein the instructions are adapted and configured for instructing said processor to interrogating a list of previous transactions for association information.

99. The electronic transaction system as claimed in claim 98, wherein the instructions are adapted and configured for instructing said processor to present one or more previous transactions associated with the initial transactor to the subsequent transactor in response to the interrogation of the list of previous transactions.

100.-101. (canceled)

102. The electronic transaction system as claimed in claim 65, wherein the subsequent transactor of the subsequent item is the same person as the initial transactor.

103.-108. (canceled)

109. An electronic online retail facilitation service comprising the steps of:
a) selling an initial item to an initial purchaser in an initial purchase; and
b) crediting the initial purchaser based on a function of one or more selected from the following:
(1) how many subsequent purchasers subsequently purchase at least one item from the seller in subsequent transactions while referencing the initial purchase;
(2) the value of subsequent purchases made by subsequent purchasers in subsequent purchases; and
(3) the date on which the subsequent purchases are made.

110.-112. (canceled)

113. An electronic transaction system that allocates credit to an initial transactor based on a transaction carried out by a subsequent transactor.

114. (canceled)

115. A method of facilitating an electronic transaction comprising the steps of
i) transacting on an item, and
ii) accruing credit to the transactor of the transaction, for allocation of said credit to an alternative transactor.

116. (canceled)
